(19) United States
(12) Patent Application Publication
(10) Pub. No.: US 2006/0080734 A1
(43) Pub. Date: Apr. 13, 2006

(54) Method and home network system for authentication between remote terminal and home network using smart card

(76) Inventors: Jong Pil Kim, Daejeon-city (KR); Sung Ik Jun, Daejeon-city (KR); Hak Du Kim, Gwangjoo-city (KR); Kyo Il Chung, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/076,727

(22) Filed: Mar. 9, 2005

(30) Foreign Application Priority Data
Oct. 11, 2004 (KR) 10-2004-0081118

(51) Int. Cl. G06F 15/16

(52) U.S. Cl. 726/15

(57) ABSTRACT

A method and home network system for authentication between a remote terminal and a home network, which are connected with each other through a network, using a smart card are provided. The method includes enabling access between the remote terminal and the home network through the network, performing authentication using first shared secret data stored in a server smart card connected to the home network and second secret data stored in a client smart card connected to the remote terminal, creating a security tunnel between the remote terminal and the home network when the authentication succeeds.

### BACKGROUND OF THE INVENTION

This application claims the priority of Korean Patent Application No. 10-2004-0081118, filed on Oct. 11, 2004, in the Korean Intellectual Property Office, the disclosure of which is incorporated herein in its entirety by reference.

1. Field of the Invention

The present invention relates to a method and home network system for authentication between a remote terminal and a home network using a smart card, and more particularly, to a home network system connecting a plurality of household appliances via a home server including a server smart card and a method for authentication between a remote user having a client smart card and the home network system through a network.

2. Description of the Related Art

Recently, a home network system has been highlighted. FIG. 1 illustrates a connection between a conventional home network and remote terminals.

Referring to FIG. 1, a plurality of household appliances (e.g., an audio device 172, a television (TV) 174, a washing machine 176, and a boiler 178) at home are connected to a household appliance network 170 installed within a building, thereby forming a home network 160 enabling the household appliances to be remotely controlled. The home network 160 is connected with a remote terminal 100 via a network 130. Even when a user is absent from home, the user can operate or monitor the household appliances in the home network 160 by operating the remote terminal 100 connected with the home network 160 via the network 130. The remote terminal 100 may be a personal computer (PC) 102, a laptop computer 104, a mobile phone 106, or a personal digital assistant (PDA) 108. The PC 102, the laptop computer 104, the mobile phone 106, and the PDA 108 are just examples of the remote terminal 100.

A home network system provides great convenience for users. However, if a safe security system is not supported, great confusion may prevail. The connection between a remote terminal and a conventional home network as shown in FIG. 1 has a problem in that an unauthorized user can access a household appliance through a network and maliciously operate them or use personal information without permission. In other words, a home network system without guarantee of safe security system may cause inconvenience instead of offering convenient life.

For authentication of a remote user accessing the conventional home network system, verification on access and authority is performed based on an identifier and a password. Accordingly, the identifier and the password must be carefully managed, which may be troublesome. Moreover, since communication data is not encrypted (i.e. plaintext is used in communication), the conventional home network is easily exposed to external attacks and is vulnerable to attacks on a home server.

To overcome these problems, expensive network security equipment has been provided for companies but is costly and burdensome to individuals. Accordingly, a home network system that provides reliable security at low cost and without burden of management is desired.

### SUMMARY OF THE INVENTION

The present invention provides a method and home network system for authentication and communication between a remote terminal and a home network using a function as a safe storage device and security function of a smart card.

The present invention also provides a method and apparatus for enhancing security in authentication, by which a home network is constructed based on a home server equipped with a smart card to allow household appliances and outside devices to communicate with each other only through the home server so that an external intruder is efficiently blocked out and only a remote user having a smart card issued by the home server is allowed to access the household appliances through the home server.

The present invention also provides an authentication system including only a remote user and a home network without a third element.

According to an aspect of the present invention, there is provided a method for authentication between a remote terminal and a home network, which are connected with each other through a network, using a smart card, the method including enabling access between the remote terminal and the home network through the network, performing authentication using first shared secret data stored in a server smart card connected to the home network and second secret data stored in a client smart card connected to the remote terminal, and when the authentication succeeds, creating a security tunnel between the remote terminal and the home network.

According to another aspect of the present invention, there is provided a method of issuing a client smart card that is connected to a remote terminal and used for authentication between the remote terminal and a home network, the method including connecting the client smart card to be used for the remote terminal to the home network, receiving shared secret data to be shared with the client smart card from a server smart card connected to the home network, and storing the shared secret data received from the server smart card in the client smart card.

According to still another aspect of the present invention, there is provided a home network system which performs authentication between a remote terminal and a home network using a smart card. Here, the home network includes a home server that is connected with a household appliance and a server smart card storing first shared secret data needed for authentication of the remote terminal, and the remote terminal includes a terminal that is connected with a client smart card storing the first shared secret data and second shared secret data needed for the authentication and, when the authentication performed between the remote terminal and the home network using the first shared secret data and the second shared secret data succeeds, controls the home network to operate the household appliance.

### BRIEF DESCRIPTION OF THE DRAWINGS

The above and other features and advantages of the present invention will become more apparent by describing in detail preferred embodiments thereof with reference to the attached drawings in which:

FIG. 1 illustrates the connection between a conventional home network and a remote terminal;

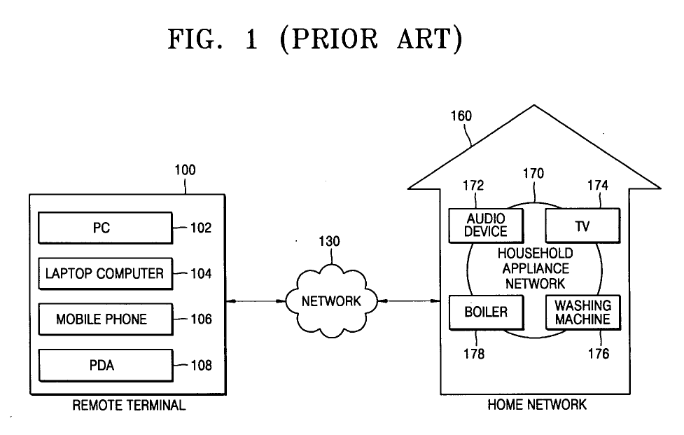

FIG. 2 illustrates the connection between a remote terminal and a home network using a smart card according to an embodiment of the present invention for authentication;

FIG. 3 is a flowchart of a procedure in which a home server issues a client smart card, according to an embodiment of the present invention;

FIG. 4 is a flowchart of an authentication procedure performed between a home server and a remote terminal, according to an embodiment of the present invention; and

FIG. 5 is a flowchart of an authentication method used between a home server and a remote terminal, according to an embodiment of the present invention.

### DETAILED DESCRIPTION OF THE INVENTION

Hereinafter, preferred embodiments of the present invention will be described in detail with reference to the attached drawings. Like reference numerals in the drawings denote like elements.

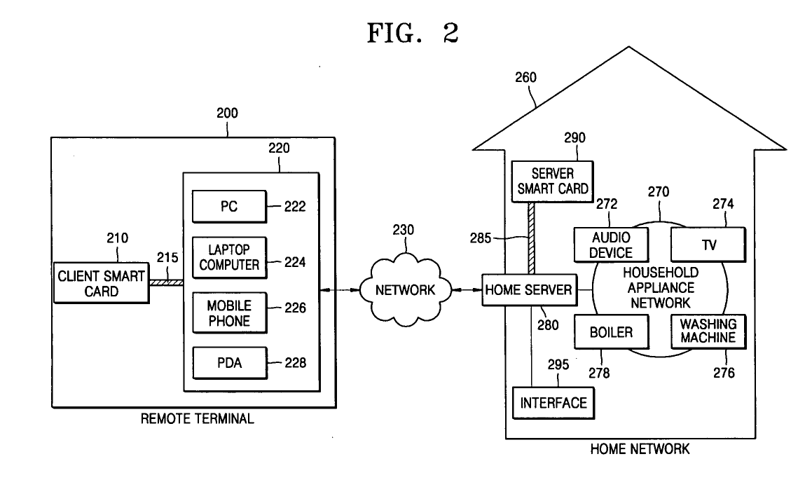

FIG. 2 illustrates the connection between a remote terminal and a home network using a smart card according to an embodiment of the present invention for authentication. Referring to FIG. 2, a home network system includes a remote terminal 200, a network 230, and a home network 260.

The network 230 is a data communication network for data exchange and processing between data devices, and particularly, may be an Internet network. However, the present invention is not restricted thereto, and the network 230 may be configured in various forms.

The remote terminal 200 accesses the home network 260 via the network 230 using a terminal 220 connected with a client smart card 210. The remote terminal 200 controls diverse household appliances included in the home network 260. The terminal 220 may be a personal computer (PC) 222, a laptop computer 224, a mobile phone 226, or a personal digital assistant (PDA) 228. The PC 222, the laptop computer 224, the mobile phone 226, and the PDA 228 are just examples of the terminal 220, and diverse modifications can be made by those skilled in the art within the scope of the present invention.

The home network 260 includes a home server 280 connected with a server smart card 290 and a household appliance network 270 which include a plurality of household appliances connected with one another and is connected with the home server 280. The outside can access the household appliances within the home network 260 only through the home server 280. Similarly, the household appliances within the home network 260 can communicate with the outside only through the home server 280.

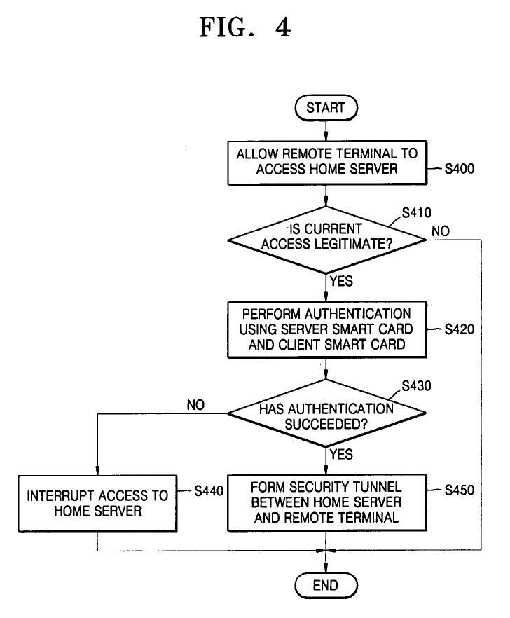

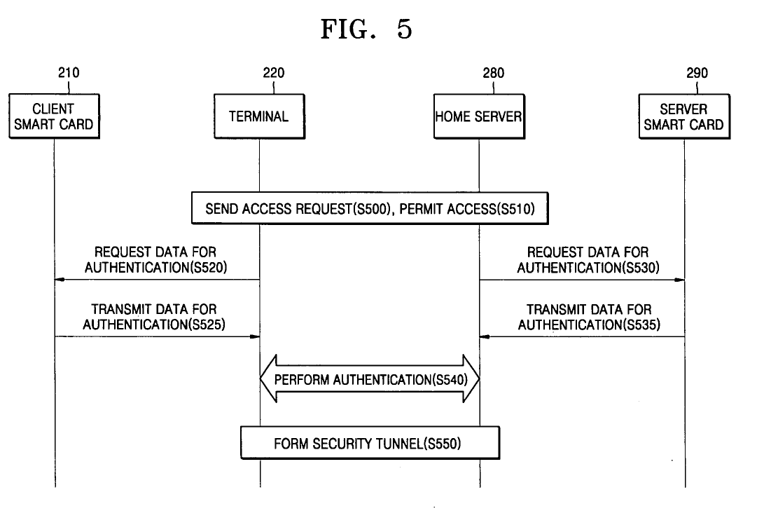

The home server 280 communicates with the terminal 220 connected with the client smart card 210 using the server smart card 290 and authenticates the remote terminal 200. After the authentication, the home server 280 creates a security tunnel between the remote terminal 200 and the home network 260 and encrypts messages used for communication, which will be described in detail with reference to FIGS. 4 and 5 later. The home server 280 includes an interface 295 connecting the server smart card 290 with the client smart card 210.

The home server 280 functions as an inevitable gateway for communication between the household appliance network 270 and the outside through the network 230 and communication between the network 230 and the household appliance network 270 and thereby blocks out malicious attacks on the home network 260. The home server 280 may further include an intrusion detector to prevent illegitimate access, such as hacking, through the network 230. When it is determined using the intrusion detector connected with the home server 280 that a current access is an illegitimate access that is not predefined by a current protocol, the home server 280 can interrupt the access.

The client smart card 210 and the server smart card 290 are respectively connected to the terminal 220 and the home server 280 through card readers (not shown) and wired/wireless connectors 215 and 285. The home server 280 may include the server smart card 290 therewithin.

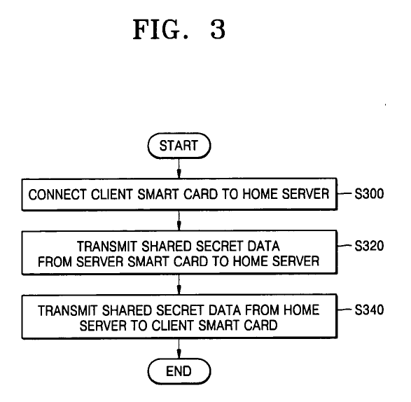

Issuing the client smart card 210 to the remote terminal 200 using the home server 280 and the server smart card 290 in the home network system described above will be described with reference to FIG. 3 below.

FIG. 3 is a flowchart of a procedure in which the home server 280 issues the client smart card 210, according to an embodiment of the present invention. Referring to FIG. 3, in operation S300, the client smart card 210 to be used for the remote terminal 200 is connected to the home server 280 through the interface 295 of the home server 280. The interface 295 may be implemented as a smart card reader or a wired connector and connected via a wired and/or wireless connection to the client smart card 210.

Next, in operation S320, the home server 280 receives shared secret data to be shared with the client smart card 210 from the server smart card 290. The server smart card 290 generates the shared secret data according to a method defined in a security policy selected when the home network system is configured. It is apparent to those skilled in the art that various security policies can be used without departing from the scope of the present invention.

Next, in operation S340, the home server 280 transmits the shared secret data to the client smart card 210.

Through this procedure, the home network system issues the client smart card 210 that can be connected to the remote terminal 200 using the home server 280 connected with the server smart card 290. As a result, security service can be provided without needing a third element other than the remote terminal 200 and the home network 260 in configuring home network security.

A procedure for safe communication through authentication between the remote terminal 200 and the home server 280 using the client smart card 210 and the server smart card 290 in the home network system having the above-described structure will be described with reference to FIG. 4 below.

FIG. 4 is a flowchart of an authentication procedure performed between the home server 280 and the remote terminal 200, according to an embodiment of the present invention.

Referring to FIG. 4, in operation S400, the terminal 220 of the remote terminal 200 accesses the home server 280 in the home network 260 via the network 230. In another embodiment of the present invention, the home server 280 may commence an access to the remote terminal 200. In this case, the terminal 220 and the client smart card 210 included in the remote terminal 200 have already been connected with each other.

Next, in operation S410, the home server 280 determines whether the access of the remote terminal 200 is legitimate via the network 230. When the access is determined as illegitimate, the access has been attempted through hacking or other illegitimate ways. Since such illegitimate access is interrupted, a security level of the home network 260 can be increased. Meanwhile, when the access is determined as legitimate, in operation S420 authentication is performed using the client smart card 210 connected with the terminal 220 of the remote terminal 200 and the server smart card 290 connected with the home server 280. For example, the authentication may be performed by determining whether results of performing a security algorithm (i.e., an authentication algorithm) based on the shared secret data transmitted to the client smart card 210 during the procedure shown in FIG. 3 are identical with each other. Here, the security algorithm for authentication is not restricted to a particular one. A smart card can support a variety of security algorithms and any one of them may be selected.

Next, in operation S430, it is determined whether the authentication between the client smart card 210 and the server smart card 290 has succeeded. When it is determined that the authentication has not succeeded, in operation S440 the home server 280 interrupts the access of the remote terminal 200.

However, when it is determined that the authentication has succeeded, in operation S450 a security tunnel is created between the home server 280 and the remote terminal 200. Messages transmitted through the security tunnel between the home server 280 and the remote terminal 200 are encrypted before being transmitted and thus not revealed to the outside. Communication between the remote terminal 200 and the home server 280 is performed through the security tunnel. A method of configuring the security tunnel varies with a type of security algorithm and is not restricted to a particular one.

FIG. 5 is a flowchart of an authentication method used between the home server 280 and the remote terminal 200, according to an embodiment of the present invention. Referring to FIG. 5, in operation S500, the terminal 220 sends an access request to the home server 280 in the home network 260 with which the terminal 220 wants to be connected. In the embodiment illustrated in FIG. 5, the terminal 220 of the remote terminal 200 sends the access request to the home server 280 of the home network 260. However, in another embodiment of the present invention, the home server 280 of the home network 260 may send the access request to the terminal 220 of the remote terminal 200.

Next, when the access request is legitimate, in operation S510 the home server 280 of the home network 260 permits an access. In the embodiment illustrated in FIG. 5, the home server 280 of the home network 260 permits the terminal 220 of the remote terminal 200 to access. However, in another embodiment of the present invention, the terminal 220 of the remote terminal 200 may permit the home server 280 of the home network 260 to access.

If the access is permitted, in operation S520 the terminal 220 requests data needed for authentication from the client smart card 210. In operation S525, the client smart card 210 transmits the data needed for authentication to the terminal 220 in response to the request from the terminal 220. Meanwhile, in operation S530, the home server 280 requests data needed for authentication from the server smart card 290. In operation S535, the server smart card 290 transmits the data needed for authentication to the home server 280 in response to the request from the home server 280.

Thereafter, in operation S540, the terminal 220 and the home server 280 perform authentication. For the authentication, an authentication algorithm is performed using a shared secret data shared by the client smart card 210 and the server smart card 290. As described above, the authentication algorithm is not restricted to a particular one.

When the authentication succeeds, in operation S550 a security tunnel is created between the terminal 220 of the remote terminal 200 and the home server 280 of the home network 260. A method of creating the security tunnel is not restricted to a particular one.

A home network system using a smart card and operations thereof according to the present invention have been described by explaining examples shown in the attached drawings. However, they may change a little according to a security algorithm performed between a client smart card and a server smart card. Accordingly, the present invention will not be restricted by the attached drawings.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through a network). The computer readable recording medium can also be distributed over network coupled computer systems so that the computer readable code is stored and executed in a distributed fashion.

The present invention provides a strict authentication method including mutual authentication between a home network and a remote terminal using a security function of a smart card and creates a safe security tunnel between the remote terminal and a home server for communication therebetween, thereby solving a conventional problem of weak security in the home network. In addition, since a client smart card is issued using a home server and a server smart card at home, a home network security system can be constructed without needing intermediation of a third party. Moreover, since a security algorithm is performed within the smart card, the present invention provides convenience and strong security for users carrying the client smart card.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for authentication between a remote terminal and a home network, which are connected with each other through a network, using a smart card, the method comprising:
(a) enabling access between the remote terminal and the home network through the network;
(b) performing authentication using first shared secret data stored in a server smart card connected to the home network and second secret data stored in a client smart card connected to the remote terminal; and
(c) when the authentication succeeds, creating a security tunnel between the remote terminal and the home network.

2. The method of claim 1, further comprising, when the authentication does not succeed, interrupting the access between the remote terminal and the home network.

3. The method of claim 1, further comprising, between operations (a) and (b):
determining whether the access between the home network and the remote terminal is a legitimate access that complies with a current protocol; and
when it is determined that the access therebetween is illegitimate, interrupting the access therebetween.

4. The method of claim 1, further comprising, before operation (a), operating the home network to control the second secret data that is identical with the first shared secret data stored in the server smart card to be stored in the client smart card.

5. A method of issuing a client smart card that is connected to a remote terminal and used for authentication between the remote terminal and a home network, the method comprising:
connecting the client smart card to be used for the remote terminal to the home network;
receiving shared secret data to be shared with the client smart card from a server smart card connected to the home network; and
storing the shared secret data received from the server smart card in the client smart card.

6. A home network system which performs authentication between a remote terminal and a home network using a smart card,
wherein the home network comprises a home server that is connected with household appliances and a server smart card storing first shared secret data needed for authentication of the remote terminal; and
the remote terminal comprises a terminal that is connected with a client smart card storing the first shared secret data and second shared secret data needed for the authentication and, when the authentication performed between the remote terminal and the home network using the first shared secret data and the second shared secret data succeeds, controls the home network to operate the household appliance.

7. The home network system of claim 6, further comprising an interface that is connected with the home server of the home network and accesses the client smart card,
wherein the home server controls the first shared secret data stored in the server smart card to be stored as the second shared secret data in the client smart card.

8. The home network system of claim 6, wherein when the authentication between the home network and the remote terminal succeeds, a security tunnel is created between the home network and the remote terminal and encrypted communication is performed therebetween.

9. The home network system of claim 6, wherein when the authentication between the home network and the remote terminal fails, access between the home network and the remote terminal is interrupted.

10. The home network system of claim 6, wherein the home server of the home network further comprises an intrusion detector that interrupts illegitimate access that does not comply with a current protocol over the network.
